(19) United States
(12) Patent Application Publication
(10) Pub. No.: US 2016/0321036 A1
(43) Pub. Date: Nov. 3, 2016

(54) DYNAMICALLY MONITORING CODE EXECUTION ACTIVITY TO IDENTIFY AND MANAGE INACTIVE CODE

(71) Applicant: BOX, INC., Los Altos, CA (US)

(72) Inventors: David Brett Schnepper, Los Gatos, CA (US); Chris Ling, Los Altos, CA (US)

(73) Assignee: BOX, INC., Los Altos, CA (US)

(21) Appl. No.: 14/698,808

(22) Filed: Apr. 28, 2015

(51) Int. Cl. G06F 9/44

(52) U.S. Cl. CPC G06F 8/30

(57) ABSTRACT

Systems for computer code development and maintenance. Embodiments select one or more sections of source code, then modify the sections of source code by adding marker code where the marker code is executed when respective marked source code is executed. The marked source code is deployed, and a logging facility receives log messages responsive to the execution of marked source code. A comparison facility is used to identify active code based on the receipt of the log messages. A service can be invoked to remove marker code from the active code identified by one or more log messages. Remaining marked code can be deemed as inactive suspects. Additional steps can process the inactive suspects to identify inactive or “dead code” code based on expiration of a time period during which the “dead code” did not emit any log messages. A further step can remove “dead code” from a code base.

### FIELD

This disclosure relates to the field of computer code development and maintenance, and more particularly to techniques for dynamically monitoring code execution activity to identify and manage inactive code.

### BACKGROUND

For large software system deployments, sections of inactive or unnecessary code (e.g., “dead code”) in the software source code can impact the performance of the system and the user experience. Specifically, inactive code can consume storage capacity and processing resources, yet not contribute to the functional capability and/or output of the software application (e.g., dead code may never be executed). Inactive code can decrease computing performance by causing unnecessary caching of instructions into the CPU instruction cache, which can further decrease data locality. Time and effort may also be spent maintaining and documenting a section of code which is never executed. Inactive code that is undiscovered can accumulate in the source code through each new release, further impacting performance and resource consumption. In some cases, such as web applications, inactive code (e.g., JavaScript, CSS, etc.) might also be distributed to the local computing device of multiple users (e.g., in a browser application), consuming network communications overhead, directly impacting the user experience and making removal of the inactive code difficult.

Various legacy approaches for removing inactive or unnecessary code are based on a static analysis of the source code. Such approaches apply a set of large, yet finite, number of possible execution scenarios to the source code to identify any branches of code that cannot ever be entered. However, such legacy approaches such as are used in static analysis are unable to discern sections of code that might be referenced—even if only under rare conditions—yet are vital to be executed under those conditions. The static analysis deployed in legacy approaches can also generate test cases to exercise code that may never be executed in deployment, resulting in inactive code being incorrectly deemed active, which in turn may introduce a deleterious performance impact on the deployed code. Further, such legacy approaches are limited in identifying inactive code in dynamic code generation environments, where references and branching scenarios are difficult to predict.

The problem to be solved is rooted in technological limitations of the legacy approaches. Improved techniques, in particular improved application of technology are needed to address the problem of reducing the impact of deploying inactive or unnecessary code. More specifically, the technologies applied in the aforementioned legacy approaches fail to achieve sought-after capabilities of the herein disclosed techniques for dynamically monitoring code execution activity to identify and manage inactive code. What is needed is a technique or techniques to improve the application and efficacy of various technologies as compared with the application and efficacy of legacy approaches.

### SUMMARY

The present disclosure provides improved systems, methods, and computer program products suited to address the aforementioned issues with legacy approaches. More specifically, the present disclosure provides a detailed description of techniques used in systems, methods, and in computer program products for dynamically monitoring code execution activity to identify and manage inactive code. Certain embodiments are directed to technological solutions for dynamically monitoring code execution over time to identify and remove inactive or unnecessary code, which embodiments advance the relevant technical fields, as well as advancing peripheral technical fields such as improving download times for Internet web applications. The disclosed embodiments modify and improve over legacy approaches. In particular, practice of the disclosed techniques reduces use of computer memory including non-volatile storage, and reduces communication overhead needed for deploying inactive code.

Some embodiment commence upon selecting one or more sections of source code, then modifying the sections of source code to add marker code where the marker code is executed when respective marked source code is executed. The marked source code is deployed, and a logging facility receives log messages responsive to the execution of the marked source code. A database engine or query engine or other comparison module is used to identify active code based on the receipt of the log messages. A service can be invoked to remove marker code from the active code identified by one or more log messages. Remaining marked code can be deemed as inactive suspects. Additional steps can process the inactive suspects to identify inactive or “dead code” code based on expiration of a time period during which the “dead code” did not emit any log messages. A further step can remove “dead code” from a code base.

Further details of aspects, objectives, and advantages of the disclosure are described below and in the detailed description, drawings, and claims. Both the foregoing general description of the background and the following detailed description are exemplary and explanatory, and are not intended to be limiting as to the scope of the claims.

### BRIEF DESCRIPTION OF THE DRAWINGS

The drawings described below are for illustration purposes only. The drawings are not intended to limit the scope of the present disclosure.

FIG. 1 depicts an environment for dynamically monitoring code execution activity to identify and manage inactive code, according to some embodiments.

FIG. 2 presents a flow diagram as used in systems for dynamically monitoring code execution activity to identify and manage inactive code, according to an embodiment.

FIG. 3A depicts code marking process steps for implementing code markers in systems that dynamically monitor code execution activity, according to some embodiments.

FIG. 3B presents a flow for configuring automated code marking as used in systems that dynamically monitor code execution activity, according to an embodiment.

FIG. 4 depicts code monitoring process steps for monitoring code execution activity in systems that dynamically monitor code execution activity, according to some embodiments.

FIG. 5 depicts code analysis process steps for analyzing code execution activity in systems that dynamically monitor code execution activity, according to some embodiments.

FIG. 6A depicts a marker insertion process as used in systems that dynamically monitor code execution activity, according to some embodiments.

FIG. 6B exemplifies a marker insertion example as used in systems that dynamically monitor code execution activity, according to some embodiments.

FIG. 7A depicts a removal process as used for removing markers in systems that dynamically monitor code execution activity, according to some embodiments.

FIG. 7B exemplifies a marker removal example as used in systems that dynamically monitor code execution activity, according to some embodiments.

FIG. 8A is a time chart showing a sequence of code release events and marker activity to identify inactive code suspects for implementing systems that dynamically monitor code execution activity to identify and manage inactive code, according to some embodiments.

FIG. 8B is a suspect age chart showing the age of suspects as used by systems that dynamically monitor code execution activity, according to some embodiments.

FIG. 9A depicts a system as an arrangement of computing modules that are interconnected so as to operate cooperatively to implement certain of the herein-disclosed embodiments.

FIG. 9B depicts a system as an arrangement of computing modules that are interconnected so as to operate cooperatively to implement certain of the herein-disclosed embodiments.

FIG. 10A and FIG. 10B depict exemplary architectures of components suitable for implementing embodiments of the present disclosure, and/or for use in the herein-described environments.

### DETAILED DESCRIPTION

Some embodiments of the present disclosure address the problem of reducing the system performance impact of deploying inactive or unnecessary code and some embodiments are directed to approaches for dynamically monitoring code execution over time to identify and remove inactive or unnecessary code. More particularly, disclosed herein and in the accompanying figures are exemplary environments, systems, methods, and computer program products for dynamically monitoring code execution activity to identify and manage inactive code.

### Overview

For large software system deployments, sections of inactive or unnecessary code (e.g., “dead code”) in the software source code can impact the performance of the system and the user experience. Specifically, inactive code can consume storage capacity and processing resources, yet not contribute to the functional capability and/or output of the software application (e.g., dead code may never be executed). Deployed or executed inactive code can decrease computing performance by causing unnecessary caching of instructions into the CPU instruction cache, which can further decrease data locality. Various legacy approaches for removing inactive or unnecessary code are based on a static analysis of the source code. Such approaches apply a set of large, yet finite, number of possible execution scenarios to the source code to identify any branches of code that cannot ever be entered. However, such legacy approaches such as are used in static analysis are unable to discern sections of code that might be referenced—even if only under rare conditions—yet are vital to be executed under those conditions. The static analysis deployed in legacy approaches can also generate test cases to exercise code that may never be executed in deployment, resulting in inactive code being incorrectly deemed active, which in turn may introduce a deleterious performance impact on the deployed code.

To address the need to reduce the system performance impact of deploying inactive or unnecessary code, the techniques described herein insert marker code into sections of source code (e.g., methods, functions, etc.) that invoke a log message when a particular section of source code, and the respective marker code, is executed (e.g., “fired”). The collection of log messages can be analyzed to identify active or “live” code, and remove the associated marker code from those sections of code. The deployment date of the marker code can also be used to measure the time a section of code has been inactive. Such inactive code suspects can be monitored and removed if they remain inactive for a certain period of time (e.g., inactive for 90 days).

Various embodiments are described herein with reference to the figures. It should be noted that the figures are not necessarily drawn to scale and that the elements of similar structures or functions are sometimes represented by like reference numerals throughout the figures. It should also be noted that the figures are only intended to facilitate the description of the disclosed embodiments—they are not representative of an exhaustive treatment of all possible embodiments, and they are not intended to impute any limitation as to the scope of the claims. In addition, an illustrated embodiment need not portray all aspects or advantages of usage in any particular environment. An aspect or an advantage described in conjunction with a particular embodiment is not necessarily limited to that embodiment and can be practiced in any other embodiments even if not so illustrated. Also, reference throughout this specification to “some embodiments” or “other embodiments” means that a particular feature, structure, material, or characteristic described in connection with the embodiments is included in at least one embodiment. Thus, the appearances of the phrase “in some embodiments” or “in other embodiments” in various places throughout this specification are not necessarily referring to the same embodiment or embodiments.

### DEFINITIONS

Some of the terms used in this description are defined below for easy reference. The presented terms and their respective definitions are not rigidly restricted to these definitions—a term may be further defined by the term's use within this disclosure. The term “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion. As used in this application and the appended claims, the term “or” is intended to mean an inclusive “or” rather than an exclusive “or”. That is, unless specified otherwise, or is clear from the context, “X employs A or B” is intended to mean any of the natural inclusive permutations. That is, if X employs A, X employs B, or X employs both A and B, then “X employs A or B” is satisfied under any of the foregoing instances. The articles “a” and “an” as used in this application and the appended claims should generally be construed to mean “one or more” unless specified otherwise or is clear from the context to be directed to a singular form.

Reference is now made in detail to certain embodiments. The disclosed embodiments are not intended to be limiting of the claims.

### Descriptions of Exemplary Embodiments

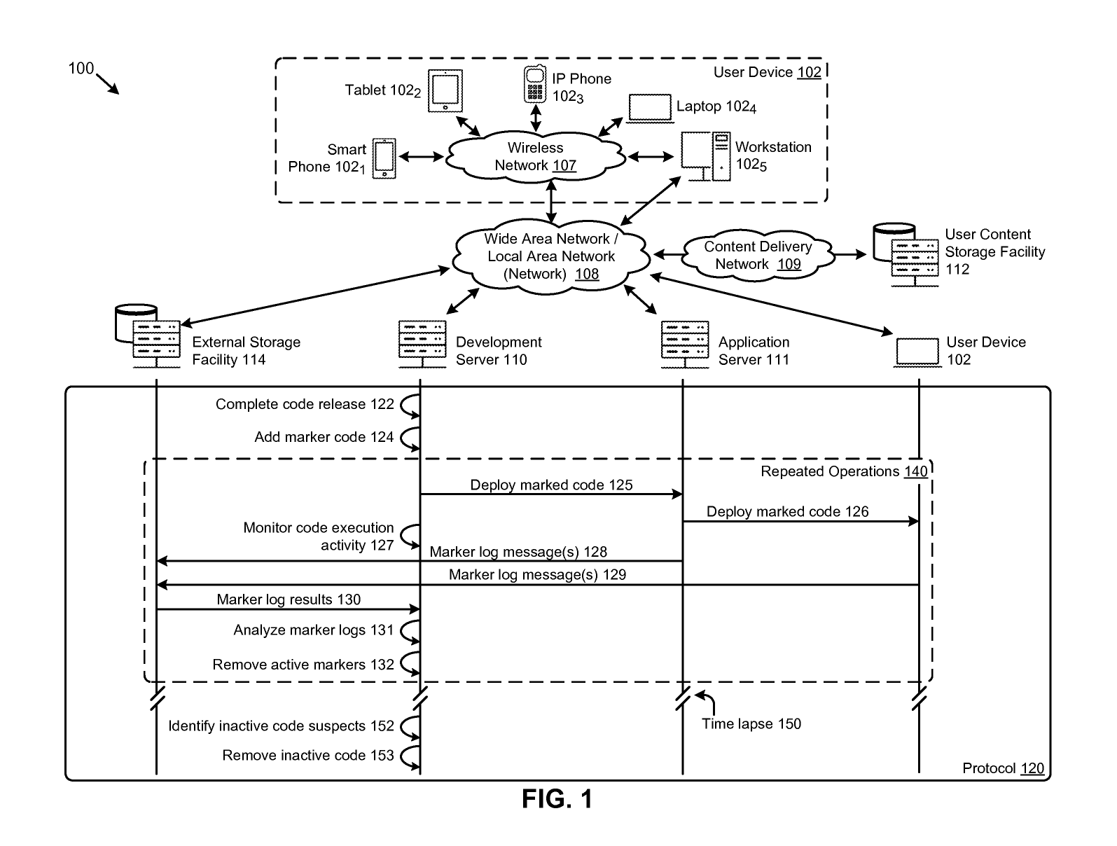

FIG. 1 depicts an environment 100 for dynamically monitoring code execution activity to identify and manage inactive code. As an option, one or more instances of environment 100 or any aspect thereof may be implemented in the context of the architecture and functionality of the embodiments described herein.

The herein-described techniques can be deployed within any computing environment. In some cases the environment may involve multiple computing resources, some of which are interconnected by a network. Some deployments may include client-server relationships between computing nodes, and some deployments may comprise a cloud architecture. One possible deployment is shown and described as pertaining to the environment 100 of FIG. 1A. The shown deployment within environment 100 comprises various computing systems (e.g., servers, clients and devices) interconnected by a wireless network 107, a network 108, and a content delivery network 109. The wireless network 107, the network 108, and the content delivery network 109 can comprise any combination of a wide area network (e.g., WAN), local area network (e.g., LAN), cellular network, wireless LAN (e.g., WLAN), or any such means for enabling communication of computing systems. The wireless network 107, the network 108, and the content delivery network 109 can also collectively be referred to as the Internet. The content delivery network 109 can comprise any combination of a public network and a private network. More specifically, environment 100 comprises at least one instance of a development server 110, at least one instance of an application server 111, at least one instance of a user content storage facility 112, and at least one instance of an external storage facility 114. The servers and storage facilities shown in environment 100 can represent any single computing system with dedicated hardware and software, multiple computing systems clustered together (e.g., a server farm), a portion of shared resources on one or more computing systems (e.g., virtual server), or any combination thereof.

The shown environment 100 further comprises at least one instance of a user device 102 that can represent one of a variety of other computing devices (e.g., a smart phone 102₁, a tablet 102₂, an IP phone 102₃, a laptop 102₄, a workstation 102₅, etc.) having hardware and software (e.g., web browser application) capable of processing and displaying information (e.g., web page, graphical user interface, etc.), and communicating information (e.g., web page request, user activity, electronic files, etc.) over the wireless network 107, the network 108, and the content delivery network 109.

In one embodiment, the user device 102, the development server 110, the application server 111, and the external storage facility 114 can exhibit a set of high-level interactions (e.g., operations, messages, etc.) in a protocol 120. Specifically, the protocol 120 can represent interactions in systems for dynamically monitoring code execution activity to identify and manage inactive code. As shown, a new release of software source code can be completed at the development server 110 (see operation 122), and marker code can be added to various sections of the source code (see operation 124). The marker code serves to indicate (e.g., by generating a log message) when the respective section of source code has been executed. The marked code is then deployed by the development server 110 to the application server 111. The application server in turn deploys marked code to one or more instances of the user device 102 (see message 125 and message 126).

Code execution activity can then be dynamically monitored (see operation 127) through the generation of marker log messages in response to real-time or live code usage at the application server 111 and/or user device 102. The generated marker log messages (see message 130) can be communicated to the external storage facility 114 for later retrieval and analyses (see message 128 and message 129). In some cases, the volume of log messages can be large, and the log messages can be sampled and/or the external storage facility can be a large capacity distributed file storage system (e.g., HDFS, etc.). At given points in time, the development server 110 can analyze the marker logs (see operation 131) to identify sections of active code and remove the respective markers from the sections of active code (see operation 132).

Various techniques for analyzing log files can be used, including but not limited to use of regular expression pattern matching (e.g., using RegEx) and/or use of SQL queries and/or HIVE queries, and/or HIVE-like queries, etc. Upon completion of a particular analysis pass, an updated marked code base with fewer (or zero) markers is then deployed and the monitoring, analyzing, and removing operations are repeated (see repeated operations 140).

After a time lapse 150 (e.g., 30 days), the collection of marker logs stored on the external storage facility 114 can be used by the development server 110 to identify code sections that have been entered during execution. The marker logs, in combination with marker data records (e.g., stored in a database of inserted markers), can be used to identify inactive code suspects (see operation 152). In particular, suspects can comprise any sections of source code where a marker was inserted, but which respective marker did not generate a log message (e.g., did not “fire”) in a given analysis period. All or a subset of the suspect sections of code can be removed from the source code base (see operation 153), where the subset can be defined by a specified period of time and/or time threshold (e.g., 30 days, 60 days, etc.) over which the suspect marker did not fire. The suspect code removal process can be automatic or manual, based in part on the complexity of the source code, the software development process and framework, and the deployment process.

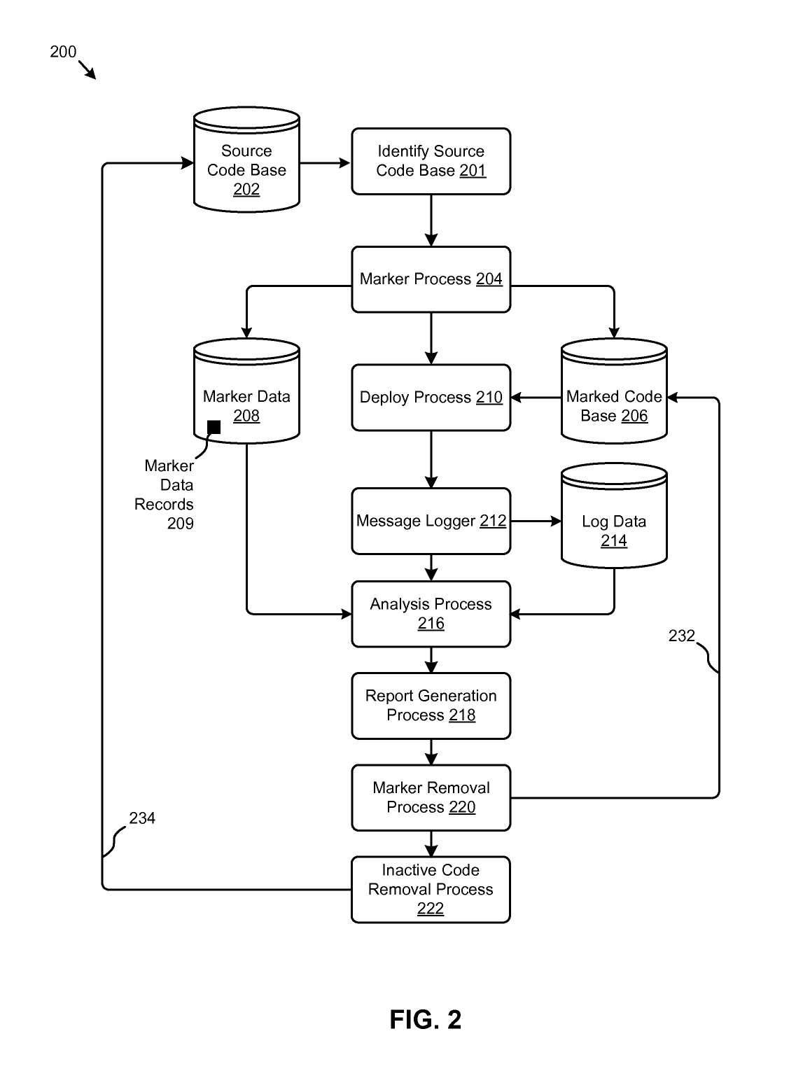

One embodiment of modules comprising a system for dynamically monitoring code execution activity to identify and manage inactive code is described as pertains to FIG. 2.

FIG. 2 presents a flow diagram 200 as used in systems for dynamically monitoring code execution activity to identify and manage inactive code. As an option, one or more instances of flow diagram 200 or any aspect thereof may be implemented in the context of the architecture and functionality of the embodiments described herein. Also, the flow diagram 200 or any aspect thereof may be implemented in any desired environment.

The flow diagram 200 represents one example of system components that can be used for dynamically monitoring code execution activity to identify and manage inactive code, according to some embodiments. Specifically, flow diagram 200 shows a source code base 202 that can be identified as a source code base (see operation 201) accessed by a marker process 204). For example, the source code base 202 can represent a new version of source code that is ready for deployment (e.g., to application server 111). The marker process 204 analyzes the source code base and adds marker code to various sections (e.g., methods, functions, branches, etc.) of the source code base. The marker code serves to indicate (e.g., by generating a log message) when the respective section of source code base 202 has been executed without impacting the functionality and capability of the source code base. The marker process 204 produces a marked code base 206 and a set of marker data 208 comprising instances of marker data records 209.

Specifically, the marked code base 206 comprises the source code base 202 with the inserted marker code, and the marker data 208 comprises marker attributes (e.g., unique location identifier, insertion date, etc.) describing each instance of the marker code. The marked code base 206 is then deployed by a deploy process (see operation 210). The deploy process communicates the marked code base to the various computing devices (e.g., application server 111, user device 102, etc.) that will execute some or all portions of the marked code base 206. A message logger 212 will receive log messages generated by the marker code when executed by the various computing devices, and store the log messages as a set of log data 214. In some embodiments, the message logger may receive and/or store a sampling of the log messages generated by the marker code.

An analysis process 216 can then analyze the log data 214 to determine various characteristics related to the execution activity of the marked code base. For example, the analysis process 216 can determine whether a particular marker has fired, and if so, when that marker fired. When the analysis process has determined from the log data that a marker has fired, the associated section of code can be characterized as active code, and the marker can be recorded or flagged for removal. The analysis process can also use the marker data and the log data to discover inactive code suspects. For example, the marker data may indicate that marker “TS-00003” was deployed on “2015-01-24”, yet the log data does not indicate that marker “TS-00003” has been fired in over 60 days. In some cases, the section of code associated with marker “TS-00003” can be characterized as an inactive code suspect, and can be recorded or flagged to be removed in a subsequent process. In other cases, a suspect can be defined by other inactivity time thresholds. A report generation process (see operation 218) can present various representations of the output of the analysis process for further system operations and/or viewing by a system user. A marker removal process 220 can be implemented to remove the marker code from sections of active code identified by the analysis process. The output of the marker removal process (e.g., updated marked code base, flagged code, hot code, etc.) serves to update the marked code base for the next deployment of the marked code base (see path 232). After a time lapse (e.g., 30 days, 60 days, etc.), the aforementioned inactive code suspects identified by the analysis process can be removed by an inactive code removal process 222. The inactive code removal process can be automatic or manual, based in part on the complexity of the source code, the software development process and framework, policies and procedures, and/or the deployment process. The output of the inactive code removal process 222 serves to update the next release of the source code base (see path 234).

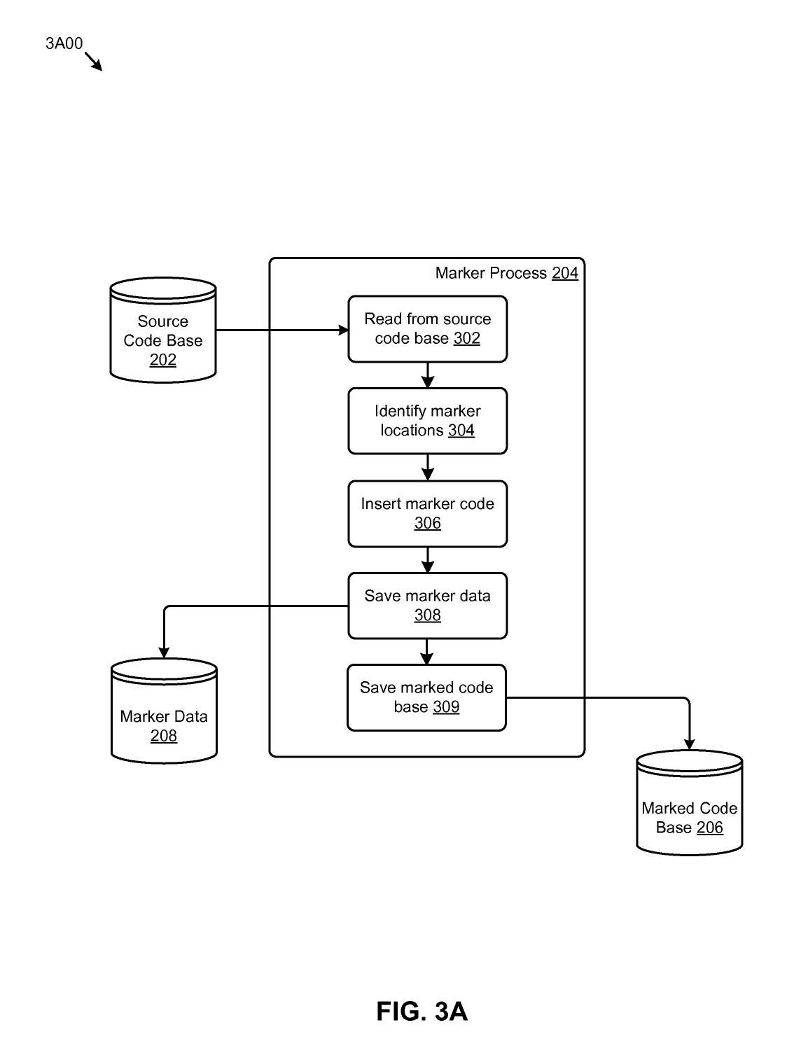

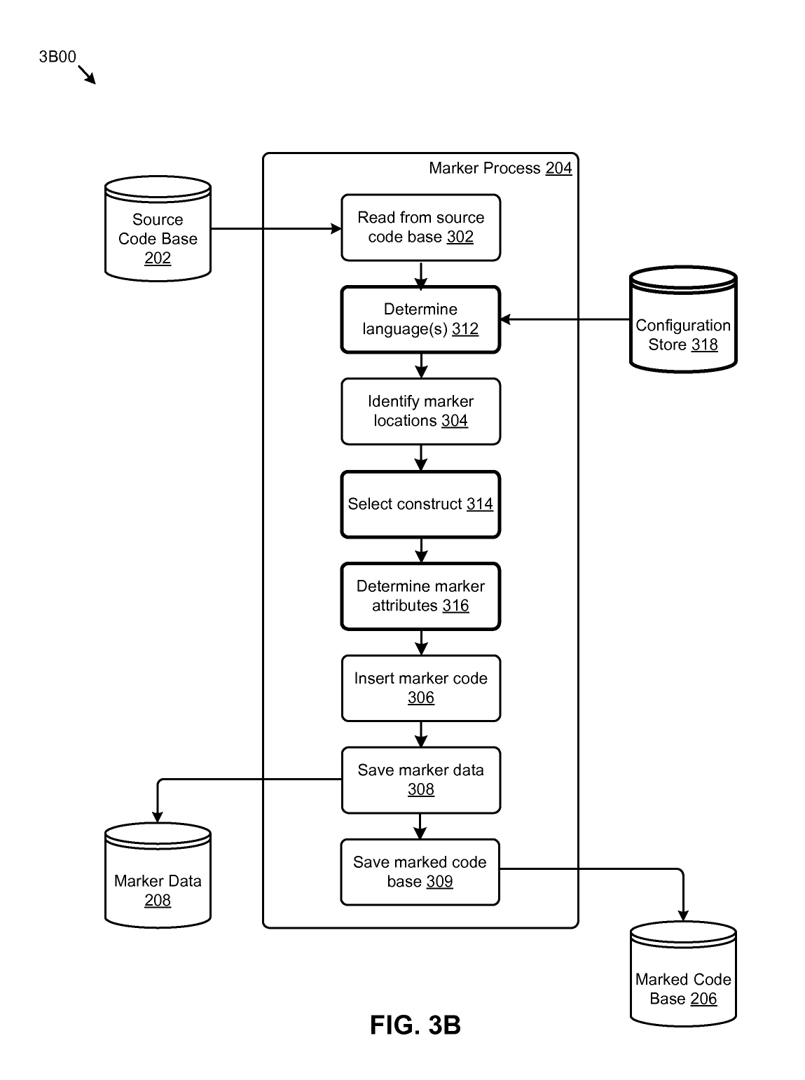

Various embodiments of the marker process are described in more detail as pertains to FIG. 3A and FIG. 3B.

FIG. 3A depicts certain code marking process steps 3A00 for implementing code markers in systems that dynamically monitor code execution activity. As an option, one or more instances of code marking process steps 3A00 or any aspect thereof may be implemented in the context of the architecture and functionality of the embodiments described herein. Also, the code marking process steps 3A00 or any aspect thereof may be implemented in any desired environment.

As shown in FIG. 3A, the code marking process steps 3A00 of the marker process 204 begin with reading from a source code base, such as source code base 202 (see step 302). The source code is analyzed (e.g., parsed, etc.) to identify sections of code in which markers are to be located (see step 304). The marker process 204 can then insert the marker code (see step 306) based at least in part on the code language and code semantics of the identified section of code. For each marker inserted, a set of associated marker data (e.g., unique location identifier, time stamp, etc.) can be saved to a storage facility such as marker data 208 (see step 308). The marker process 204 can further save the marked code base to a storage facility, such as the marked code base 206 (see step 309). Additional steps that can be implemented in the marker process 204 for configuring automated code marking are described as pertains to FIG. 3B.

FIG. 3B presents a flow 3B00 for configuring automated code marking as used in systems that dynamically monitor code execution activity. As an option, one or more instances of flow 3B00 or any aspect thereof may be implemented in the context of the architecture and functionality of the embodiments described herein. Also, the flow 3B00 or any aspect thereof may be implemented in any desired environment.

The flow 3B00 comprises the steps and components shown in FIG. 3A, and further comprises additional steps (e.g., step 312, step 314, and step 316) and a configuration store 318. Specifically, the shown embodiment of the marker process 204 can determine the one or more software languages (see step 312) comprising the source code base 202. The language of the code can serve to enable the identification of marker locations (see step 304) and the construct of the marker used at each location (see step 314). For example, the marker construct can be based at least in part on the language (e.g., Javascript, PHP, Python, Ruby, etc.) and the code section type (e.g., method, function, branch, etc.).

In step 312, various approaches can be used to identify the source language of the computer code. This approaches include filename pattern recognition (e.g., by convention, Python filenames end with “.php”), internal marker identification (e.g., by convention, PHP files start with the text “<?PHP”), full parse analysis (e.g., when the program complies with the Ruby syntax), or by direct identification by a user (e.g., by the presence of an identification such as, “this source file contains Fortran”).

In step 304, various approaches can be used to identify the locations to insert markers into the source language program, and such locations can be based on the language or syntax identified in step 312. For instance, many languages support a code constructions termed “named code blocks” and/or “functions” and/or “and/or procedures” and/or “methods” depending on the syntax, semantics, and conventions of the language being used. The location of an inserted marker can depend from the construction. For example, a named code block can only be entered at its start point, and such a start point is an appropriate location for placement of a marker. Further, many languages support a branching structure, such as “if A then B else C”. Such a branching structure can be recognized once the computer programming language is determined (see step 312). The code blocks corresponding to “B” and “C” can then be modified to become “B2” and “C2” by the addition of a marker at the beginning of the code block. In this example, the code block “A” does not need to be marked since A can be inferred to be unused code if both “B2” and “C2” are deemed to be unused code. Code constructs for identifying exceptional code paths (e.g., Java exceptions) are also handled. Many languages have a structure similar to “try A catch B do C”. In this construct, “C” is marked to create “C1”. The construction for “B” does not need marking as it will be used if-and-only-if “C1” reports itself as used code. The code portion “A” will always be used code if the code block prior to the “try” construct is used code. In this case, it is not necessary to place a marker in “A”.

As previously indicated, the construction of a marker call can be made dependent on the programming language (e.g., the programming language determined in step 312). In a programming language such as Python, a suitable marker can be a module method call such as “marker (B, C)”. The marker, in this embodiment, takes two parameters, “B” and “C”. The parameter “B” identifies a date that operation 124 was executed, and can be represented in a plain-text format suitable for reading by humans and/or by machines (for example “2015-01-23”). The parameter “C” can be constructed to be unique within the scope of the code release. Such a marker having a parameter “C” can be placed into the software code and can serve as a date as well as a unique identifier for this marker. Many alternative approaches to creation of unique markers are reasonable. One alternative approach is to use a name (e.g., a human readable name or a machine readable name) of the code release (e.g., including the version identifier of the release, such as “V1”, “V2”, etc.), and to that, append the date that operation 124 was started, and to that, append an incrementing count for each marker placed in the code base. Additional identification may be added to the marker to reduce the possibility of a false match. Such additional identification may be present in the form of boilerplate text and/or text that distinguishes over source file constructs previously present in the normal operation of the code release, and/or additional parameters provided in the marker call.

In some embodiments, the mapping of languages and section types to marker constructs can be stored in the configuration store 318. The configuration store 318 can further comprise other attributes that can be associated with an inserted marker (see step 316). For example, a software designer may assign a long inactive threshold (e.g., 180 days) to a particular marker when the designer realizes the conditions required to execute the associated section of code are relatively infrequent (e.g., user-specific code for an internal legacy driver), yet that section of code is vital when those conditions are met. The flow 3B00 continues from step 306 as described as pertains to FIG. 3A.

The configuration store 318 can further be used to preserve information between invocations of protocol 120. For example, if it is deemed (e.g., by discovery during execution of protocol 120) that a method named “HotCode” is frequently used, then on a next execution of protocol 120, a data structure can be accessed so as to receive instructions to not place a marker in the method named “HotCode”. Strictly as one example, an engineer or code designer can place instructions into a configuration store based on the engineer's or code designer's domain-specific knowledge pertaining to the code release.

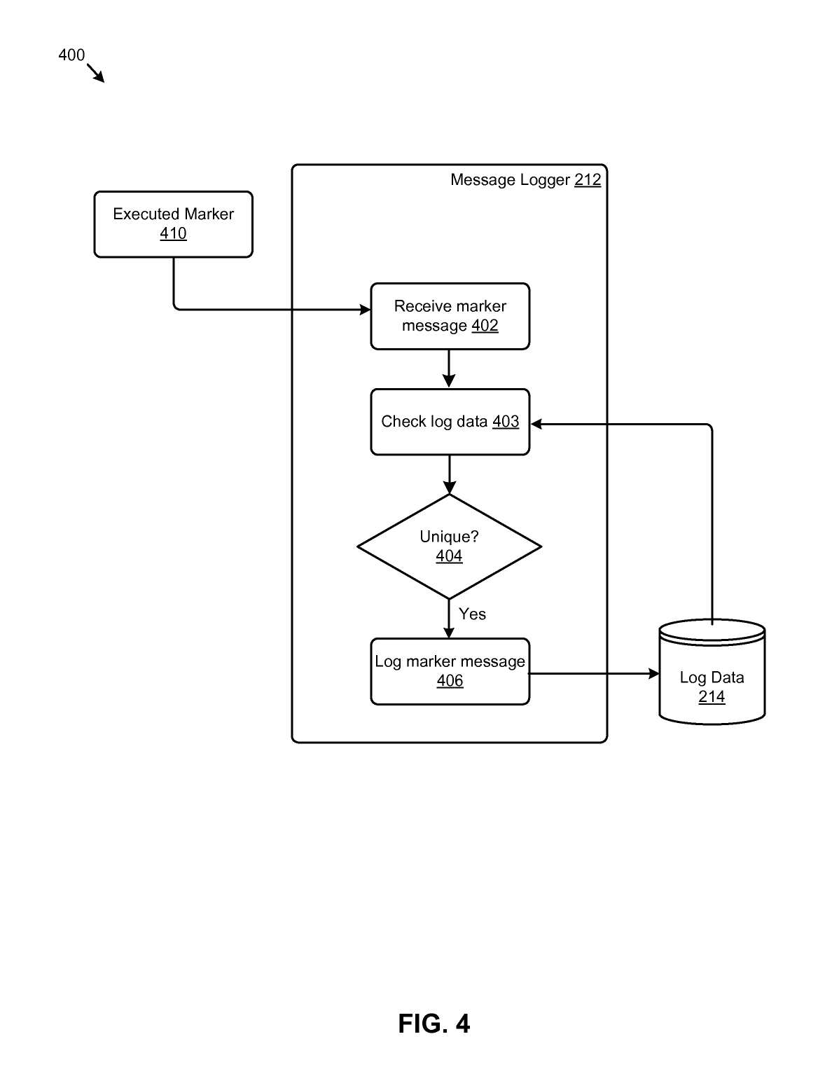

FIG. 4 describes one embodiment of a code monitoring process implemented by the message logger 212 from FIG. 2.

FIG. 4 depicts an instance of code monitoring process steps 400 for monitoring code execution activity in systems that dynamically monitor code execution activity. As an option, one or more instances of code monitoring process steps 400 or any aspect thereof may be implemented in the context of the architecture and functionality of the embodiments described herein. Also, the code monitoring process steps 400 or any aspect thereof may be implemented in any desired environment.

As shown in FIG. 4, the code monitoring process steps 400 of the message logger 212 begin with receiving a message from an executed marker 410 (see step 402). The received marker message is checked (see operation 403) against the existing information in the log data 214 to determine if the received marker message is unique (see decision 404). In some cases, a marker message can be characterized as unique when the marker associated with the marker message has never been fired. In other cases, a marker message can be characterized as unique when the marker associated with the marker message has not been fired in a certain time window (e.g., 1 day). Various other attributes can be used by decision 404 to manage (e.g., sample) the incoming messages. If the marker message is characterized as unique, the message logger 212 will log the marker message in the log data 214 (see step 406).

Software code can execute very rapidly, and can often execute in loops. The reduction of non-unique data (see decision 404) is used in some embodiments so as to manage performance and to manage the utilization of data storage facilities. It is not necessary to eliminate the logging of non-unique data, nor is it necessary to log all available data. Data that is logged is used in operation 131, and operation 132 can serve to remove the markers that generate the recurring log entries. In one embodiment, message logger 212 stores the last N marker identifiers that attempted to log. If a new attempt L is not in the list, it is sent to the log data store, and L is added to the remembered list. Another embodiment counts how many messages were sent to the log data store, and stops logging messages when a particular limit (e.g., a daily limit M) is reached.

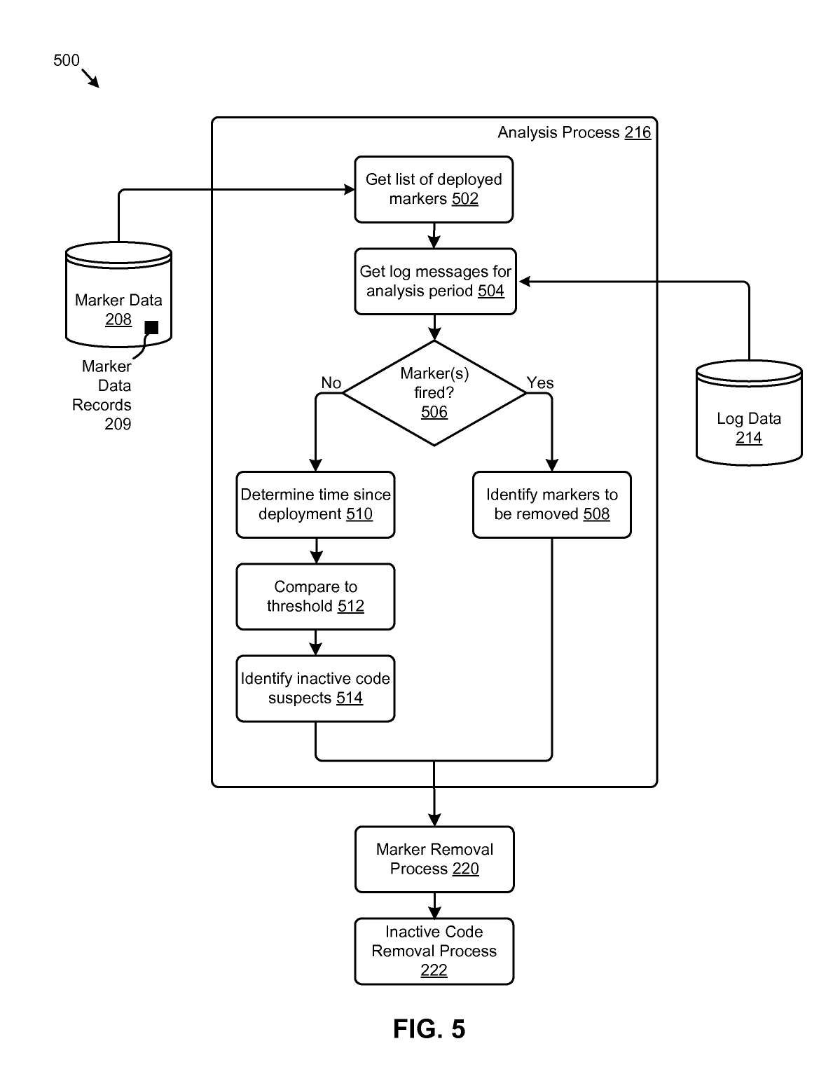

FIG. 5 depicts an instance of code analysis process steps 500 for analyzing code execution activity in systems that dynamically monitor code execution activity. As an option, one or more instances of code analysis process steps 500 or any aspect thereof may be implemented in the context of the architecture and functionality of the embodiments described herein. Also, the code analysis process steps 500 or any aspect thereof may be implemented in any desired environment.

As shown in FIG. 5, the code analysis process steps 500 of the analysis process begin with getting a list of marker data records 209 (e.g., deployed markers) from the marker data 208 (see step 502). For a given analysis period, a set of log messages are also retrieved from the log data 214 (see step 504). For example, when the analysis process 216 is executed daily, the analysis period might be the past 24 hours. The analysis process 216 will examine the retrieved log messages to determine if one or more markers have been fired (see decision 506). If the log messages indicate (e.g., by reference to a location identifier and timestamp) that a marker has been fired, then the marker is characterized (e.g., flagged) as identified for removal from the marked code base (see step 508). If the log messages do not indicate that one or more deployed markers (e.g., as specified by the marker data records stored in marker data 208) have been fired, these unfired markers are further examined as being associated with potential inactive code suspects. Specifically, the marker data 208 is used to determine the time since deployment of the unfired markers (see step 510). The resulting time is compared to a threshold (see step 512). For example, a software designer may assign a threshold to a marker associated with a particular section of code such that, if the marker did not fire within that threshold, the particular section of code could be identified as inactive and/or unnecessary with acceptable confidence (see step 514). In one or more embodiments, the results and output generated by the analysis process 216 (e.g., markers to be removed, identified suspects, etc.) can be used by other components (e.g., marker removal process 220, inactive code removal process 222, etc.) in systems that dynamically monitor code execution activity to identify and manage inactive code.

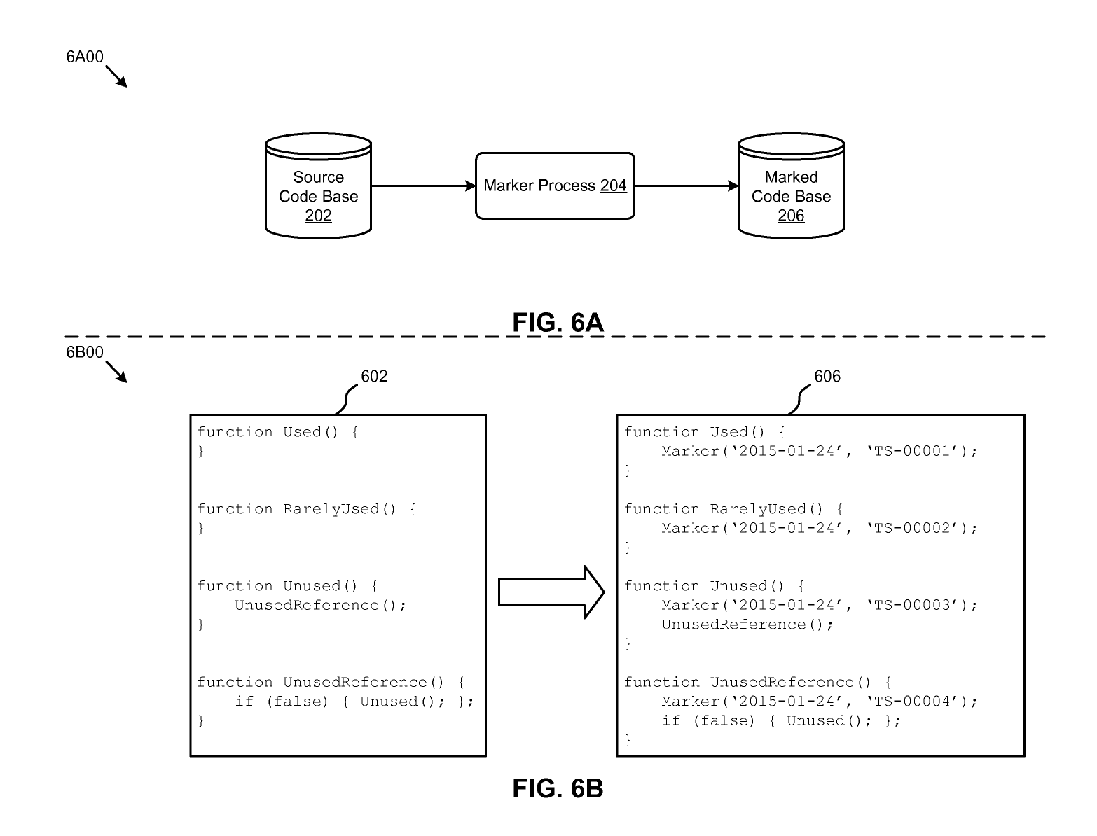

FIG. 6A depicts a marker insertion process 6A00 as used in systems that dynamically monitor code execution activity. As an option, one or more instances of marker insertion process 6A00 or any aspect thereof may be implemented in the context of the architecture and functionality of the embodiments described herein. Also, the marker insertion process 6A00 or any aspect thereof may be implemented in any desired environment.

As shown, the marker insertion process 6A00 comprises the marker process 204 that reads the source code base 202 and generates the marked code base 206. An example of the marker insertion process 6A00 is shown in FIG. 6B.

FIG. 6B exemplifies a marker insertion example 6B00 as used in systems that dynamically monitor code execution activity. As an option, one or more instances of marker insertion example 6B00 or any aspect thereof may be implemented in the context of the architecture and functionality of the embodiments described herein. Also, the marker insertion example 6B00 or any aspect thereof may be implemented in any desired environment.

The marker insertion example 6B00 depicts a set of example source code 602 that is operated on (e.g., by the marker process 204) to generate a set of example marked code 606. As shown, the example marked code 606 is functionally identical to the example source code 602, yet with the addition of calls to a “Marker” method at the start of each code section. In this example, the parameters associated with the “Marker” method are the marker deployment date (e.g., “2015-03-24”) and a unique location identifier (e.g., “TS-00001”) that identifies the marker and it associated section of code. In some embodiments, the example marked code 606 replaces the example source code 602 in a source code repository (e.g., marked code base 206), and can be released through a code release process.

An example implementation of the “Marker” method is shown in Table 1.

TABLE 1

| Ref | Information |
|---|---|
| 1 | function Tombstone ($marker_date, $marker_identifier) { |

| | |
|---|---|
| 2 | $fn = fopen(‘/logs/Marker.log’, ‘a’); |
| 3 | fwrite(fn, “$todays_date, $hostname, $marker_date, |

| | |
|---|---|
| 4 | $marker_identifer\n”); |

| | |
|---|---|
| 5 | fclose ($fn); |

| | |
|---|---|
| 6 | } |

This example implementation, when executed, will record that a marker with a given unique identifier and deployment date was exercised on the current date (e.g., ““$todays_date”) and hostname (e.g., “$hostname”), into a log file (e.g., “/logs/Marker.log”).

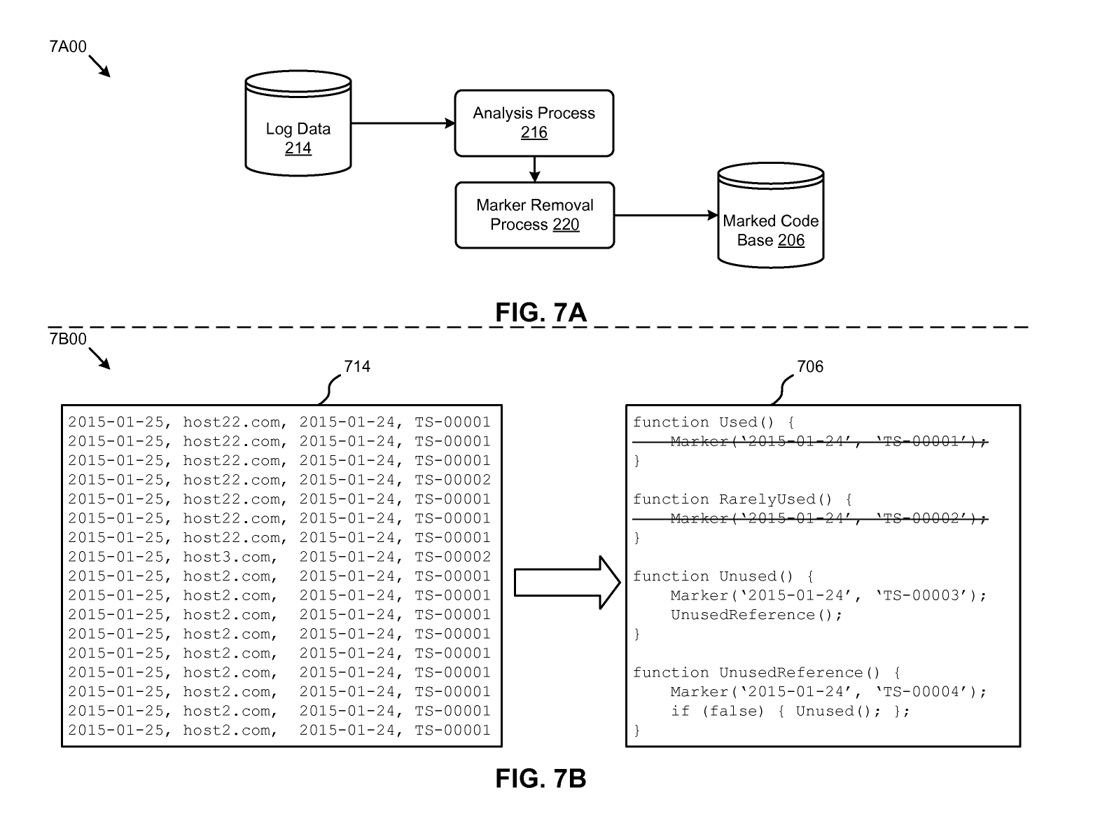

FIG. 7A depicts a removal process 7A00 as used for removing markers in systems that dynamically monitor code execution activity. As an option, one or more instances of the removal process 7A00 or any aspect thereof may be implemented in the context of the architecture and functionality of the embodiments described herein. Also, the removal process 7A00 or any aspect thereof may be implemented in any desired environment.

As shown, the removal process 7A00 comprises the analysis process 216 and marker removal process 220 that analyzes the log data 214 to identify and remove markers from the marked code base 206. An example of the removal process 7A00 is shown in FIG. 7B.

FIG. 7B exemplifies a marker removal example 7B00 as used in systems that dynamically monitor code execution activity. As an option, one or more instances of marker removal example 7B00 or any aspect thereof may be implemented in the context of the architecture and functionality of the embodiments described herein. Also, the marker removal example 7B00 or any aspect thereof may be implemented in any desired environment.

The marker removal example 7B00 depicts a set of example marker logs 714 that is operated on (e.g., by the analysis process 216 and the marker removal process 220) to identify and remove markers as shown in a set of updated marked code 706. As shown in the example marker logs 714, various markers (e.g., “TS-00001”) have been recorded as being fired at specific times (e.g., “2015-01-24”) and from specific servers (e.g., “host22.com”). In some embodiments, the log data 214 can be aggregated to facilitate faster processing. For example, repeated messages received from a given marker from a particular server on a particular date can be aggregated into a single log record further comprising a count of the number of repeated messages received. In some embodiments, any markers that have been logged as firing in the log data 214 will be removed from the marked code base 206. Specifically, the example marker logs 714 show that markers “TS-00001” and “TS-00002” have fired, and are indicated as removed in the updated marked code 706. The example marker logs 714 do not indicate that markers “TS-00003” and “TS-00004” have fired, so those markers are left in the updated marked code 706 as shown.

In one or more embodiments, the removal process 7A00 is repeated daily. A more frequent or less frequent schedule can also be implemented. Any code associated with markers that have not fired (e.g., “TS-00003” and “TS-00004”) after a specified time period can be declared inactive or unnecessary and be subject to removal. Such removal could either be performed manually (e.g., by software engineers) or by an automated process if supported by the software system being monitored.

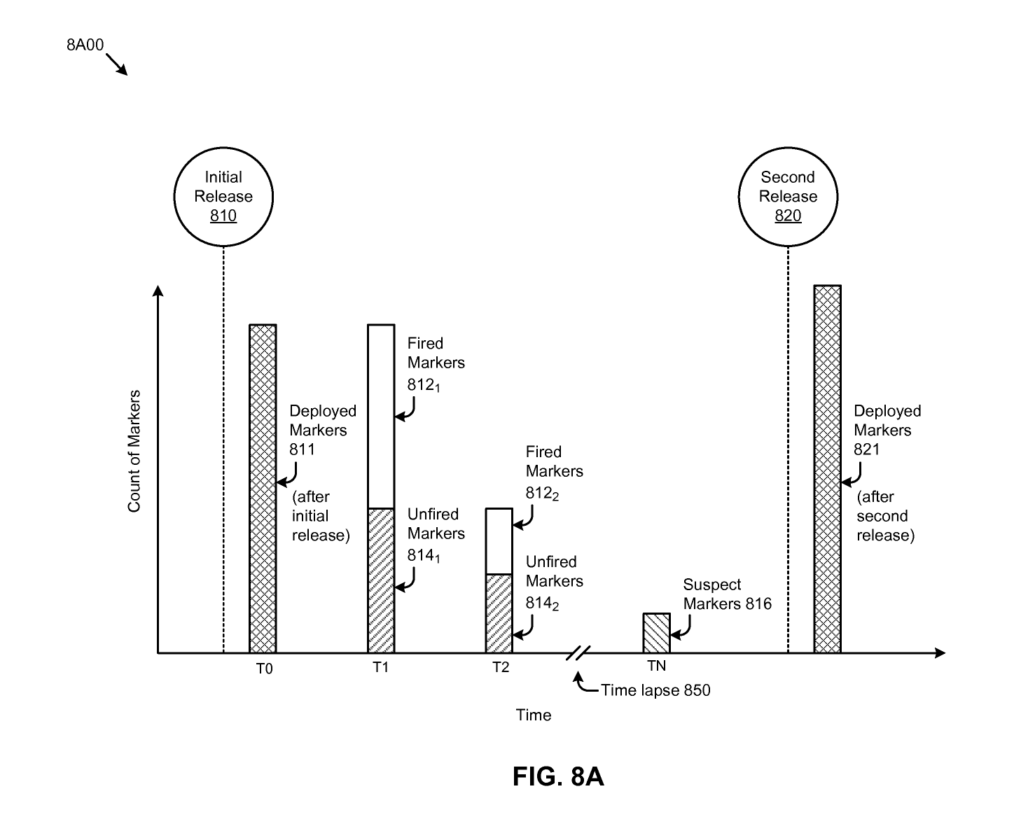

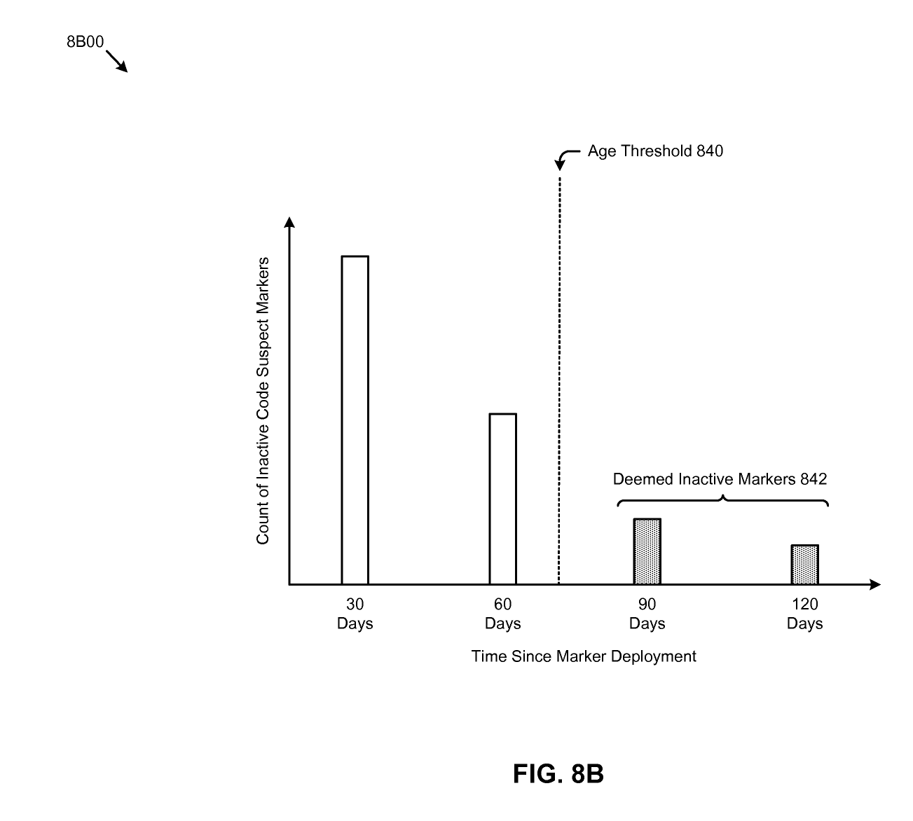

FIG. 8A is a time chart 8A00 showing a sequence of code release events and marker activity to identify inactive code suspects for implementing systems that dynamically monitor code execution activity to identify and manage inactive code. As an option, one or more instances of time chart 8A00 or any aspect thereof may be implemented in the context of the architecture and functionality of the embodiments described herein. Also, the time chart 8A00 or any aspect thereof may be implemented in any desired environment.

The bars on the time chart 8A00 illustrate the count of various types of markers (e.g., fired markers, unfired markers) deployed in a given software release, and monitored and identified using the herein disclosed techniques. Specifically, time chart 8A00 shows that in response to an initial release 810, a set of deployed markers 811 can be included in a marked code base (e.g., marked code base 206) associated with the source code of the initial release 810. At a time T1 corresponding to invoking a first code activity analysis process (e.g., see FIG. 5), a set of fired markers 812₁ and a set of unfired markers 814₁ can be identified. In one or more embodiments, the fired markers 812₁ can be removed from the marked code base and the marked code base redeployed. A second code activity analysis can be invoked as a time T2, identifying a different set of fired markers 812₂ and set of unfired markers 814₂, the set of fired markers 812₂ comprising markers that had not yet fired at the time T1 (e.g., one day earlier). In some cases, after a time lapse 850 (e.g., 30 days), only unfired markers described as a set of inactive code suspect markers 816 can remain. The inactive code suspect markers 816 are associated with the sections of code that have not been executed since the initial release 810. Such code may be characterized as inactive or unnecessary based at least in part on the time lapse 850. In one or more embodiments, when a second release 820 is ready for deployment, a new set of deployed markers 821 (e.g., after second release) are inserted into a marked code base associated with the source code of the second release 820, for continuing code activity monitoring and analyses. In some embodiments, markers that have fired in previous releases (e.g., fired markers 812₁ and fired markers 812₂) are also included in the deployed markers 821 (after second release).

In some cases, the sections of code associated with the inactive code suspect markers 816 can be characterized as inactive or unnecessary based at least in part on the time (e.g., time lapse 850) the code has been inactive. More specifically, a time threshold can be set for one or more markers to indicate a time beyond which an unfired marker could indicate, with an acceptable confidence, the associated section of code is inactive and/or unnecessary. A graphical representation of a set of inactive code suspect markers of various “age” (e.g., time span since deployment without firing) is shown in FIG. 8B.

FIG. 8B is a suspect age chart 8B00 showing the age of suspects as used by systems that dynamically monitor code execution activity. As an option, one or more instances of suspect age chart 8B00 or any aspect thereof may be implemented in the context of the architecture and functionality of the embodiments described herein. Also, the suspect age chart 8B00 or any aspect thereof may be implemented in any desired environment.

The suspect age chart 8B00 shows a graphical representation of a set of inactive code suspect markers of various “age” (e.g., time span since deployment without firing). As shown, the inactive code suspect markers are categorized as having not fired within 30, 60, 90, and 120 days of deployment. In some embodiments, an age threshold 840 can be established to automatically identify and remove sections of code suspected to be inactive based on the associated marker age. For example, if the age threshold 840 is set to 75 days, then the sections of code associated with a set of inactive markers 842 (e.g., inactive for 90 days and 120 days) can be automatically removed from the source code.

### Additional Embodiments of the Disclosure

### Additional Practical Application Examples

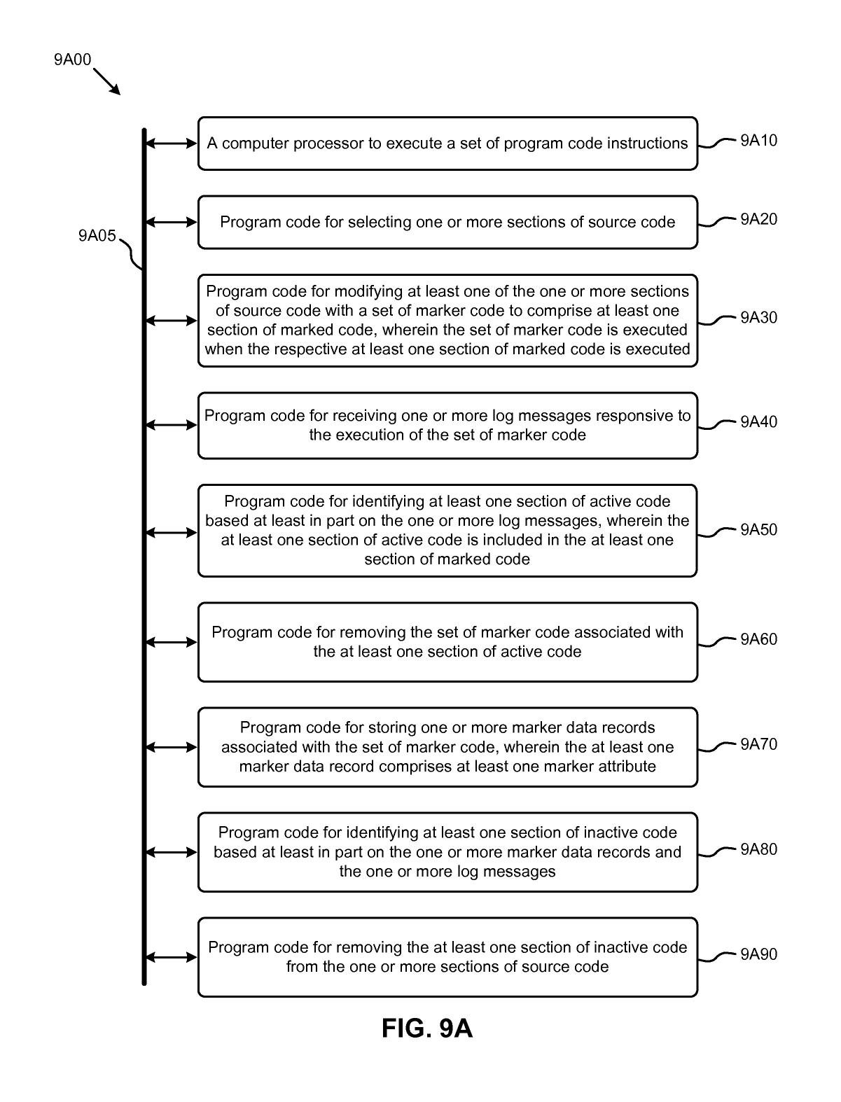

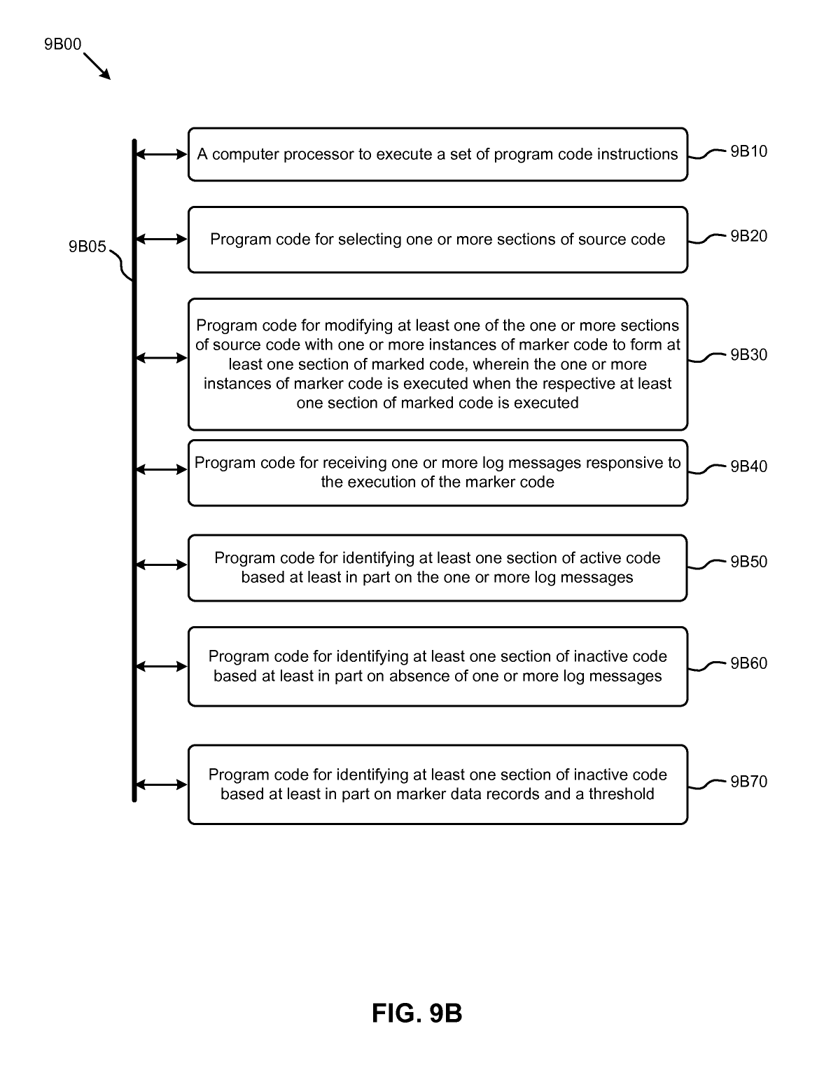

FIG. 9A depicts a system 9A00 as an arrangement of computing modules that are interconnected so as to operate cooperatively to implement certain of the herein-disclosed embodiments. The partitioning of system 9A00 is merely illustrative and other partitions are possible.

The system 9A00 comprises at least one processor and at least one memory, the memory serving to store program instructions corresponding to the operations of the system. As shown, an operation can be implemented in whole or in part using program instructions accessible by a module. The modules are connected to a communication path 9A05, and any operation can communicate with other operations over communication path 9A05. The modules of the system can, individually or in combination, perform method operations within system 9A00. Any operations performed within system 9A00 may be performed in any order unless as may be specified in the claims.

The shown embodiment in FIG. 9A implements a portion of a computer system, shown as system 9A00, comprising a computer processor to execute a set of program code instructions (see module 9A10) and modules for accessing memory to hold program code instructions to perform: selecting one or more sections of source code (see module 9A20); modifying at least one of the one or more sections of source code with a set of marker code to comprise at least one section of marked code, wherein the set of marker code is executed when the respective at least one section of marked code is executed (see module 9A30); receiving one or more log messages responsive to the execution of the set of marker code (see module 9A40); identifying at least one section of active code based at least in part on the one or more log messages, wherein the at least one section of active code is included in the at least one section of marked code (see module 9A50); removing the set of marker code associated with the at least one section of active code (see module 9A60); storing one or more marker data records associated with the set of marker code, wherein the at least one marker data record comprises at least one marker attribute (see module 9A70); identifying at least one section of inactive code based at least in part on the one or more marker data records and the one or more log messages (see module 9A80); and, removing the at least one section of inactive code from the one or more sections of source code (see module 9A90).

In one or more embodiments, the system 9A00 further comprises marker code that is based at least in part on one or more code attributes of the one or more sections of source code. In one or more embodiments, the one or more code attributes describe at least one of, a code language and a code construct. In some embodiments, code attributes describe a thread characteristic (e.g., a runnable thread that implements Java Runnable class). In some embodiments, code attributes describe a code construct characteristic (e.g., a function characteristic, a method characteristic, a TRUE branch characteristic, a FALSE branch characteristic, an exception catch characteristic, etc.). In one or more embodiments, the at least one marker attribute describes at least one of, a location identifier and a deployment time, and wherein the one or more log messages comprise at least one of, the location identifier, an execution time, and an execution source identifier. In one or more embodiments, the identifying of the at least one section of inactive code is based at least in part on an age of marker code associated with the at least one section of inactive code, wherein the age is determined at least in part on a difference between a measurement time and the deployment time. In one or more embodiments, the identifying of the at least one section of inactive code is based at least in part on a relationship between the age and a marker threshold.

FIG. 9B depicts a system 9B00 as an arrangement of computing modules that are interconnected so as to operate cooperatively to implement certain of the herein-disclosed embodiments. The partitioning of system 9B00 is merely illustrative and other partitions are possible. The modules are connected to a communication path 9B05, and any operation can communicate with other operations over communication path 9B05. The modules of the system can, individually or in combination, perform method operations within system 9B00. Any operations performed within system 9B00 may be performed in any order unless as may be specified in the claims. The shown embodiment in FIG. 9B implements a portion of a computer system, shown as system 9B00, comprising a computer processor to execute a set of program code instructions (see module 9B10) and modules for accessing memory to hold program code instructions to perform: selecting one or more sections of source code (see module 9B20); modifying at least one of the one or more sections of source code with one or more instances of marker code to form at least one section of marked code, wherein the one or more instances of marker code is executed when the respective at least one section of marked code is executed (see module 9B30); receiving one or more log messages responsive to the execution of the marker code (see module 9B40); identifying at least one section of active code based at least in part on the one or more log messages (see module 9B50); identifying at least one section of inactive code based at least in part on an absence of one or more log messages (see module 9B60); and identifying at least one section of inactive code based at least in part on marker data records and a threshold (see module 9B70).

### System Architecture Overview

### Additional System Architecture Examples

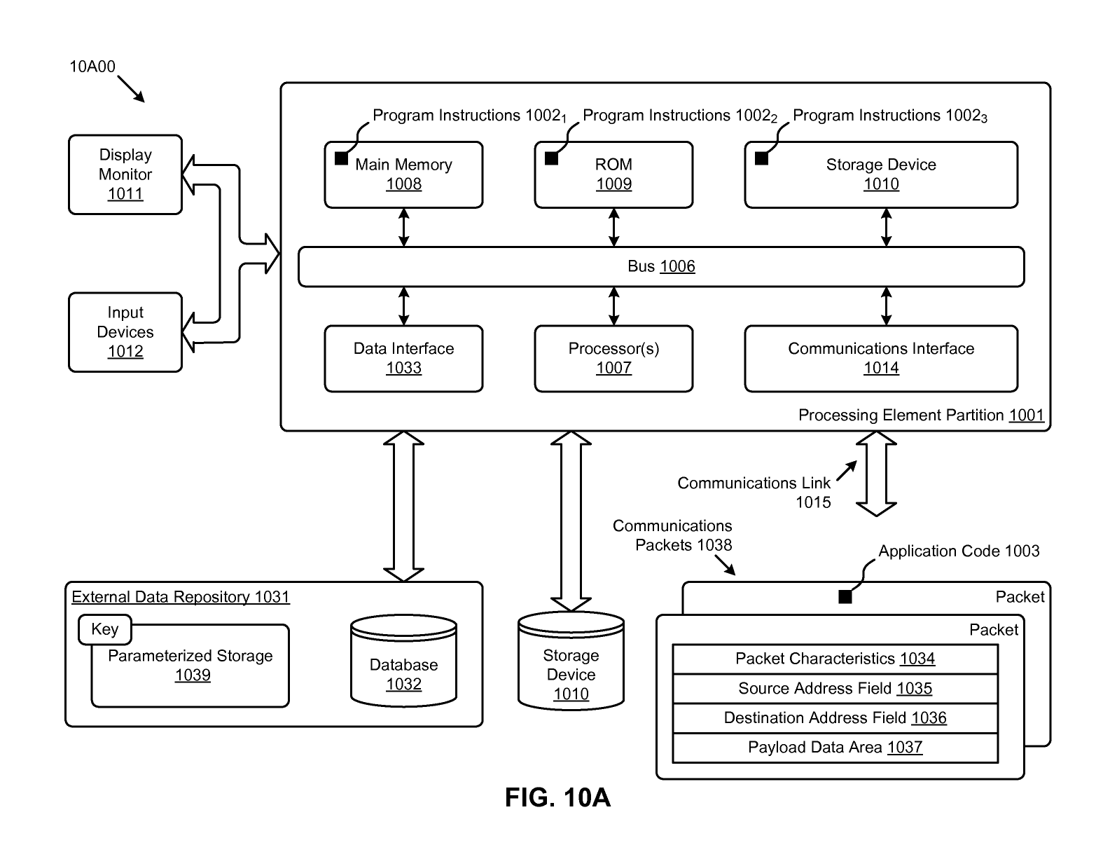

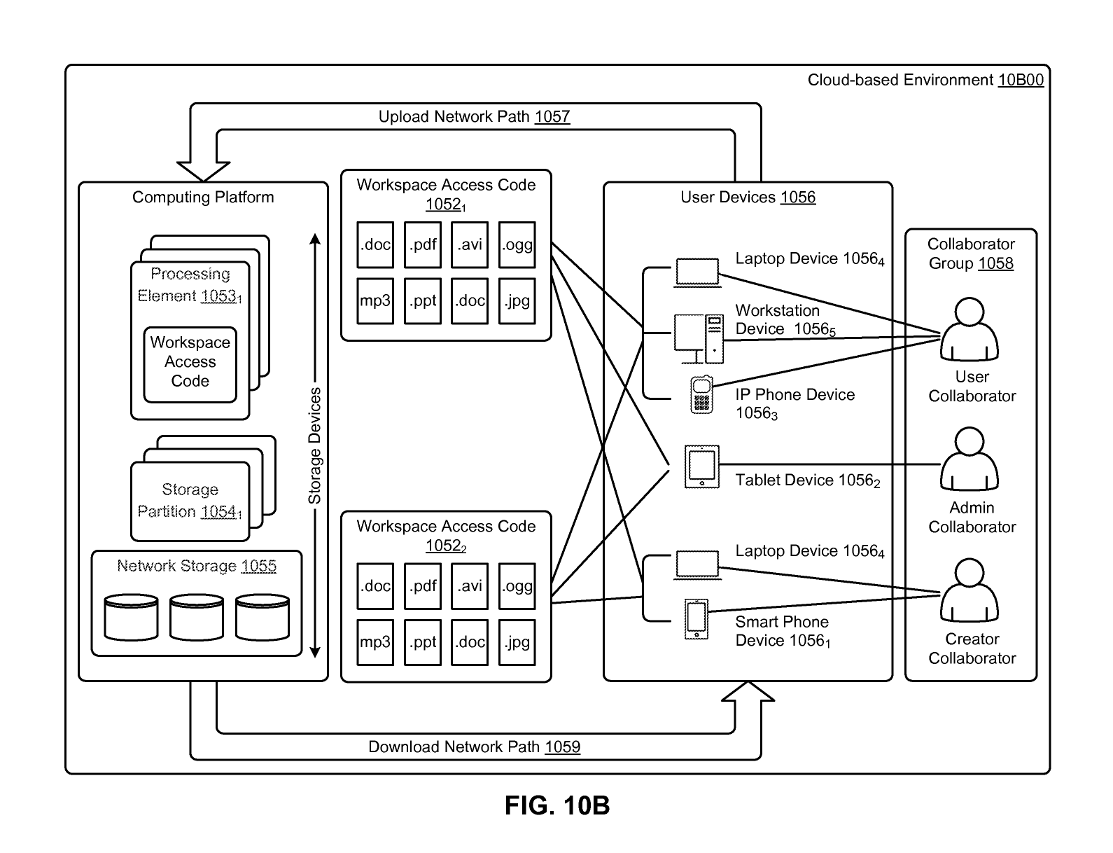

FIG. 10A depicts a block diagram of an instance of a computer system 10A00 suitable for implementing embodiments of the present disclosure. Computer system 10A00 includes a bus 1006 or other communication mechanism for communicating information. The bus interconnects subsystems and devices such as a CPU, or a multi-core CPU (e.g., processor 1007), a system memory (e.g., main memory 1008, or an area of random access memory RAM), a non-volatile storage device or area (e.g., ROM 1009), an internal or external storage device 1010 (e.g., magnetic or optical), a data interface 1033, a communications interface 1014 (e.g., PHY, MAC, Ethernet interface, modem, etc.). The aforementioned components are shown within processing element partition 1001, however other partitions are possible. The shown computer system 10A00 further comprises a display 1011 (e.g., CRT or LCD), various input devices 1012 (e.g., keyboard, cursor control), and an external data repository 1031.

According to an embodiment of the disclosure, computer system 10A00 performs specific operations by processor 1007 executing one or more sequences of one or more program code instructions contained in a memory. Such instructions (e.g., program instructions 1002₁, program instructions 1002₂, program instructions 1002₃, etc.) can be contained in or can be read into a storage location or memory from any computer readable/usable medium such as a static storage device or a disk drive. The sequences can be organized to be accessed by one or more processing entities configured to execute a single process or configured to execute multiple concurrent processes to perform work. A processing entity can be hardware-based (e.g., involving one or more cores) or software-based, and/or can be formed using a combination of hardware and software that implements logic, and/or can carry out computations and/or processing steps using one or more processes and/or one or more tasks and/or one or more threads or any combination therefrom.

According to an embodiment of the disclosure, computer system 10A00 performs specific networking operations using one or more instances of communications interface 1014. Instances of the communications interface 1014 may comprise one or more networking ports that are configurable (e.g., pertaining to speed, protocol, physical layer characteristics, media access characteristics, etc.) and any particular instance of the communications interface 1014 or port thereto can be configured differently from any other particular instance. Portions of a communication protocol can be carried out in whole or in part by any instance of the communications interface 1014, and data (e.g., packets, data structures, bit fields, etc.) can be positioned in storage locations within communications interface 1014, or within system memory, and such data can be accessed (e.g., using random access addressing, or using direct memory access DMA, etc.) by devices such as processor 1007.

The communications link 1015 can be configured to transmit (e.g., send, receive, signal, etc.) communications packets 1038 comprising any organization of data items. The data items can comprise a payload data area 1037, a destination address 1036 (e.g., a destination IP address), a source address 1035 (e.g., a source IP address), and can include various encodings or formatting of bit fields to populate the shown packet characteristics 1034. In some cases the packet characteristics include a version identifier, a packet or payload length, a traffic class, a flow label, etc. In some cases the payload data area 1037 comprises a data structure that is encoded and/or formatted to fit into byte or word boundaries of the packet.

In some embodiments, hard-wired circuitry may be used in place of or in combination with software instructions to implement aspects of the disclosure. Thus, embodiments of the disclosure are not limited to any specific combination of hardware circuitry and/or software. In embodiments, the term “logic” shall mean any combination of software or hardware that is used to implement all or part of the disclosure.

The term “computer readable medium” or “computer usable medium” as used herein refers to any medium that participates in providing instructions to processor 1007 for execution. Such a medium may take many forms including, but not limited to, non-volatile media and volatile media. Non-volatile media includes, for example, optical or magnetic disks such as disk drives or tape drives. Volatile media includes dynamic memory such as a random access memory.

Common forms of computer readable media includes, for example, floppy disk, flexible disk, hard disk, magnetic tape, or any other magnetic medium; CD-ROM or any other optical medium; punch cards, paper tape, or any other physical medium with patterns of holes; RAM, PROM, EPROM, FLASH-EPROM, or any other memory chip or cartridge, or any other non-transitory computer readable medium. Such data can be stored, for example, in any form of external data repository 1031, which in turn can be formatted into any one or more storage areas, and which can comprise parameterized storage 1039 accessible by a key (e.g., filename, table name, block address, offset address, etc.).

Execution of the sequences of instructions to practice certain embodiments of the disclosure are performed by a single instance of the computer system 10A00. According to certain embodiments of the disclosure, two or more instances of computer system 10A00 coupled by a communications link 1015 (e.g., LAN, PTSN, or wireless network) may perform the sequence of instructions required to practice embodiments of the disclosure using two or more instances of components of computer system 10A00.

The computer system 10A00 may transmit and receive messages such as data and/or instructions organized into a data structure (e.g., communications packets 1038). The data structure can include program instructions (e.g., application code 1003), communicated through communications link 1015 and communications interface 1014. Received program code may be executed by processor 1007 as it is received and/or stored in the shown storage device or in or upon any other non-volatile storage for later execution. Computer system 10A00 may communicate through a data interface 1033 to a database 1032 on an external data repository 1031. Data items in a database can be accessed using a primary key (e.g., a relational database primary key).

The processing element partition 1001 is merely one sample partition. Other partitions can include multiple data processors, and/or multiple communications interfaces, and/or multiple storage devices, etc. within a partition. For example, a partition can bound a multi-core processor (e.g., possibly including embedded or co-located memory), or a partition can bound a computing cluster having plurality of computing elements, any of which computing elements are connected directly or indirectly to a communications link. A first partition can be configured to communicate to a second partition. A particular first partition and particular second partition can be congruent (e.g., in a processing element array) or can be different (e.g., comprising disjoint sets of components).

A module as used herein can be implemented using any mix of any portions of the system memory and any extent of hard-wired circuitry including hard-wired circuitry embodied as a processor 1007. Some embodiments include one or more special-purpose hardware components (e.g., power control, logic, sensors, transducers, etc.). A module may include one or more state machines and/or combinational logic used to implement or facilitate the performance characteristics of systems for dynamically monitoring code execution activity to identify and manage inactive code.

Various implementations of the database 1032 comprise storage media organized to hold a series of records or files such that individual records or files are accessed using a name or key (e.g., a primary key or a combination of keys and/or query clauses). Such files or records can be organized into one or more data structures (e.g., data structures used to implement or facilitate aspects of dynamically monitoring code execution activity to identify and manage inactive code). Such files or records can be brought into and/or stored in volatile or non-volatile memory.

FIG. 10B depicts a block diagram of an instance of a cloud-based environment 10B00. Such a cloud-based environment supports access to workspaces through the execution of workspace view code (e.g., workspace access code 1052₁ and workspace access code 1052₂. Workspace access code can be executed on any of the shown user devices 1056 (e.g., laptop device 1056₄, workstation device 1056₅, IP phone device 1056₃, tablet device 1056₂, smart phone device 1056ₖ, etc.), or on one or more processing elements. A group of users can form a collaborator group 1058, and a collaborator group can be comprised of any types or roles of users. For example, and as shown, a collaborator group can comprise a user collaborator, an administrator collaborator, a creator collaborator, etc. Any user can use any one or more of the user devices, and such user devices can be operated concurrently to provide multiple concurrent sessions and/or other techniques to access workspaces through the workspace access code.

A portion of workspace access code can reside in and be executed on any user device. Also, a portion of the workspace access code can reside in and be executed on any computing platform, including in a middleware setting. As shown, a portion of the workspace access code resides in and can be executed on one or more processing elements (e.g., processing element 1053₁). The workspace access code can interface with storage devices such the shown network storage 1055. Storage of workspaces and/or any constituent files or objects, and/or any other code or scripts or data can be stored in any one or more storage partitions (e.g., storage partition 1054₁). In some environments, a processing element includes forms of storage such as RAM and/or ROM and/or FLASH, and/or other forms of volatile and non-volatile storage.

A stored workspace can be populated via an upload (e.g., an upload from a user device to a processing element over an upload network path 1057). A stored workspace can be delivered to a particular user and/or shared with other particular users via a download (e.g., a download from a processing element to a user device over a download network path 1059).

In the foregoing specification, the disclosure has been described with reference to specific embodiments thereof. It will, however, be evident that various modifications and changes may be made thereto without departing from the broader spirit and scope of the disclosure. For example, the above-described process flows are described with reference to a particular ordering of process actions. However, the ordering of many of the described process actions may be changed without affecting the scope or operation of the disclosure. The specification and drawings to be regarded in an illustrative sense rather than in a restrictive sense.

What is claimed is:

1. A method comprising:
selecting one or more sections of source code;
modifying at least one of the one or more sections of source code with one or more instances of marker code to form at least one section of marked code, wherein the one or more instances of marker code is executed when the respective at least one section of marked code is executed;
receiving one or more log messages responsive to the execution of the marker code;
identifying at least one section of active code based at least in part on the one or more log messages; and
identifying at least one section of inactive code based at least in part on the one or more log messages.

2. The method of claim 1, wherein the one or more instances of marker code is based at least in part on one or more code attributes of the one or more sections of source code.

3. The method of claim 2, wherein the one or more code attributes describe at least a thread characteristic or a code construct characteristic.

4. The method of claim 1, further comprising removing at least a portion of marker code from the active code identified by one or more log messages.

5. The method of claim 1, further comprising a storing of one or more marker data records associated with the one or more instances of marker code, wherein the at least one marker data record comprises at least one marker attribute.

6. The method of claim 5, wherein the at least one marker attribute describes at least one of, a location identifier and a deployment time, and wherein the one or more log messages comprises at least one of, the location identifier, and an execution time.

7. The method of claim 6, further comprising a removing the at least one section of inactive code from the one or more sections of source code.

8. The method of claim 7, wherein the identifying of the at least one section of inactive code is based at least in part on an age of marker code associated with the at least one section of inactive code, wherein the age is determined at least in part on a difference between a measurement time and the deployment time.

9. The method of claim 8, wherein the identifying of the at least one section of inactive code is based at least in part on a relationship between the age and a marker threshold.

10. The method of claim 1 wherein the one or more instances of marker code comprises a deployment date.

11. A computer program product, embodied in a non-transitory computer readable medium, the computer readable medium having stored thereon a sequence of instructions which, when executed by a processor causes the processor to execute a process, the process comprising:
selecting one or more sections of source code;
modifying at least one of the one or more sections of source code with one or more instances of marker code to form at least one section of marked code, wherein the one or more instances of marker code is executed when the respective at least one section of marked code is executed;
receiving one or more log messages responsive to the execution of the marker code;
identifying at least one section of active code based at least in part on the one or more log messages; and
identifying at least one section of inactive code based at least in part on the one or more log messages.

12. The computer program product of claim 11, wherein the one or more instances of marker code is based at least in part on one or more code attributes of the one or more sections of source code.

13. The computer program product of claim 12, wherein the one or more code attributes describe at least a thread characteristic or a code construct characteristic.

14. The computer program product of claim 11, further comprising removing at least a portion of marker code from the active code identified by one or more log messages.

15. The computer program product of claim 11, further comprising a storing of one or more marker data records associated with the one or more instances of marker code, wherein the at least one marker data record comprises at least one marker attribute.

16. The computer program product of claim 15, wherein the at least one marker attribute describes at least one of, a location identifier and a deployment time, and wherein the one or more log messages comprises at least one of, the location identifier, and an execution time.

17. The computer program product of claim 11, further comprising a removing the at least one section of inactive code from the one or more sections of source code.

18. The computer program product of claim 11 wherein the one or more instances of marker code comprises a deployment date.

19. A system comprising:
a development server to select one or more sections of source code and modify at least one of the one or more sections of source code with one or more instances of marker code to form at least one section of marked code, wherein the one or more instances of marker code is executed when the respective at least one section of marked code is executed;
an application server to receiving one or more log messages responsive to the execution of the marker code, and to identify at least one section of active code based at least in part on the one or more log messages; and
a comparison module to identify at least one section of inactive code based at least in part on the one or more log messages.

20. The system of claim 19, further comprising a module to identify at least one section of inactive code based at least in part on marker data records,
wherein the at least one marker attribute describes at least one of, a location identifier and a deployment time, and
wherein the one or more log messages comprises at least one of, the location identifier, and an execution time.
